(19) United States
(12) Patent Application Publication
(10) Pub. No.: US 2018/0091958 A1
(43) Pub. Date: Mar. 29, 2018

(54) COMMUNICATION TERMINAL APPARATUS AND COMMUNICATION SYSTEM

(71) Applicant: SHARP KABUSHIKI KAISHA, Sakai City, Osaka (JP)

(72) Inventors: TETSUROH MORIWAKI, Sakai City (JP); TAKASHI ONODERA, Sakai City (JP); YASUO SUGAWARA, Sakai City (JP); MASAFUMI ARAMOTO, Sakai City (JP); YOSHITAKA SUZUKI, Sakai City (JP)

(21) Appl. No.: 15/553,189

(22) PCT Filed: Feb. 27, 2015
(86) PCT No.: PCT/JP2015/055990

§ 371 Date: Aug. 24, 2017

(51) Int. Cl. H04W 4/12; H04M 3/42; H04W 68/00; H04W 52/02

(52) U.S. Cl. CPC H04W 4/12; H04M 3/42017; H04W 52/0229; H04W 52/0267; H04W 68/005

(57) ABSTRACT

Information that a called person desires to inform a calling person of is reported during a call made by the calling person, and it is notified that the calling person has acquired the information. A communication terminal apparatus that performs telephone communications via a communication network includes: a conversation unit 144 that inputs therein a sound via a transmitter and outputs a sound from a receiver; an input unit 110 that receives an operation of a user; a display unit 140 that displays an image; a communication unit 120 that establishes communications with a server 300, which is provided on the communication network, on a basis of a telephone number of a calling destination, which is input from the input unit 110; and a notification unit 130 that, in a case where the communication unit 120 acquires multimedia data corresponding to the telephone number of the calling destination from the server 300 after the communications are established with the server 300, notifies the user of acquisition of the multimedia data.

### TECHNICAL FIELD

The present invention relates to a communication terminal apparatus and a communication system that perform telephone communications via a communication network.

### BACKGROUND ART

Conventionally, a system which is equipped on a telephone network provided by a communication carrier and by which a sound source of ring-back tone (ring sounded from a receiver of a telephone terminal of a calling side) is able to be changed to a user's favorite melody or the like has been known. For example, in a system for changing ring-back tone sound source described in PTL 1, a ring-back tone sound source content is registered in a sound source storage device for each user, and, when a telephone call is made from a telephone terminal of the user, the registered ring-back tone sound source content is transmitted to the telephone terminal of the user as ring-back tone during calling a called person. It is thereby possible to make a calling person listen to the content of a sound instead of the ring-back tone.

Moreover, as a practical application of the aforementioned technique, a technique by which a web page image corresponding to a telephone number of a calling destination is displayed after making a telephone call has been known. For example, in a telephone communication system described in PTL 2, in a case of calling from a mobile telephone terminal with a specific telephone number as a calling destination, a web page image corresponding to the telephone number of the calling destination is automatically displayed on a display unit of the mobile telephone terminal of a calling source. For example, in a case of calling a bookstore, a web page image showing an address and business hours related to the bookstore is displayed on the mobile telephone terminal.

### CITATION LIST

### Patent Literature

PTL 1: Japanese Unexamined Patent Application Publication No. 2004-088452

PTL 2: Japanese Patent No. 4750493

### SUMMARY OF INVENTION

### Technical Problem

However, even if a sound content substituted for ring-back tone or an image content is transmitted to a calling person, there are some cases where the calling person does not notice. With the conventional techniques, it is difficult to achieve an effect thereof, in a case where a calling person does not notice acquisition of a content.

The invention has been made in view of such circumstances, and an object thereof is to provide a communication terminal apparatus and a communication system which are able to report, during a call made by a calling person, information that a called person desires to inform the calling person of and to notify that the calling person has acquired the information.

### Solution to Problem

(1) In order to achieve the aforementioned object, the invention provides means as described below. That is, a communication terminal apparatus of the invention is a communication terminal apparatus that performs telephone communications via a communication network, including; a conversation unit that inputs therein a sound via a transmitter and outputs a sound from a receiver; an input unit that receives an operation of a user; a display unit that displays an image; a communication unit that establishes communications with a server apparatus, which is provided on the communication network, on the basis of a telephone number of a calling destination, which is input from the input unit; and a notification unit that, in a case where the communication unit acquires multimedia data corresponding to the telephone number of the calling destination from the server apparatus after the communications are established with the server apparatus, notifies the user of acquisition of the multimedia data.

As above, the communications are established with the server apparatus, which is provided on the communication network, on the basis of the telephone number of the calling determination, which is input from the input unit, and, in the case where the communication unit acquires multimedia data corresponding to the telephone number of the calling determination from the server apparatus after the communications are established with the server apparatus, the user is notified of the acquisition of the multimedia data, so that it is possible to make the user notice the acquisition of the multimedia data. Thereby, it is possible to make the user listen to or view the multimedia data instead of ring-back tone.

(2) Moreover, the communication terminal apparatus of the invention further includes a vibrator that vibrates a housing of the communication terminal apparatus, in which the notification unit causes the vibrator to function, in a case where the communication unit acquires multimedia data.

As above, in the case where the communication unit acquires multimedia data, the vibrator is caused to function, so that it is possible to cause the user to tactually recognize the acquisition of the multimedia data.

(3) Moreover, in the communication terminal apparatus of the invention, in the case where the communication unit acquires multimedia data, the notification unit outputs, from the receiver, a sound which indicates that the multimedia data is acquired.

As above, in the case where the communication unit acquires multimedia data, the sound which indicates that the multimedia data is acquired is output from the receiver, so that it is possible to cause the user to aurally recognize the acquisition of the multimedia data.

(4) Moreover, in the communication terminal apparatus of the invention, in the case where the communication unit acquires multimedia data, the notification unit displays, on the display unit, an image which indicates that the multimedia data is acquired.

As above, in the case where the communication unit acquires multimedia data, the image which indicates that the multimedia data is acquired is displayed on the display unit, so that it is possible to cause the user to visually recognize the acquisition of the multimedia data.

(5) Moreover, the communication terminal apparatus of the invention further includes an external speaker that outputs a sound, in which, in the case where the communication unit acquires multimedia data, the notification unit outputs, from the external speaker, a sound which indicates that the multimedia data is acquired.

As above, in the case where the communication unit acquires multimedia data, the sound which indicates that the multimedia data is acquired is output from the external speaker, so that it is possible to cause the user to aurally recognize the acquisition of the multimedia data. Particularly, even when the user does not hold the receiver to his or her ear, the sound is output from the external speaker, so that aural notification is enabled.

(6) Moreover, the communication terminal apparatus of the invention further includes a conversation determination unit that, in the case where the communication unit acquires multimedia data, determines whether or not a proximity sensor of the communication terminal apparatus is reacting, and a reproduction unit that reproduces or stops the multimedia data in accordance with a result of the determination.

As above, since whether or not the proximity sensor of the communication terminal apparatus is reacting is determined and the multimedia data is reproduced or stopped in accordance with the result of the determination, in a case where the proximity sensor is reacting, the multimedia data is reproduced to thereby make the user to listen to the sound, and, on the other hand, in a case where the proximity sensor is not reacting, the multimedia data is stopped to thereby avoid reproduction of the sound which is not to be listened to by the user. Moreover, in the case where the proximity sensor is not reacting, it is possible to make the user view a video by reproducing the multimedia data, and, on the other hand, in the case where the proximity sensor is reacting, by stopping the multimedia data, it is possible to avoid reproduction of the video which is not to be viewed by the user.

(7) Moreover, in the communication terminal apparatus of the invention, in a case where the communication unit acquires multimedia data from the server apparatus, the display unit displays an image included in the acquired multimedia data, or the conversation unit outputs a sound included in the acquired multimedia data from the receiver.

As above, in the case where multimedia data is acquired from the server apparatus, the display unit displays the image included in the acquired multimedia data, or the conversation unit outputs the sound included in the acquired multimedia data from the receiver, so that it is possible to make the user listen to or view the multimedia data instead of so-called ring-back tone.

(8) Moreover, the communication terminal apparatus of the invention further includes a control unit that monitors a remaining amount of a battery of the communication terminal apparatus and controls operations of the conversation unit and the display unit, in which, in the case where the communication unit acquires multimedia data from the server apparatus, in accordance with the remaining amount of the battery of the communication terminal apparatus, the control unit decides whether or not to display the image included in the acquired multimedia data, or decides whether or not to output the sound included in the acquired multimedia data.

As above, in the case where the communication unit acquires multimedia data from the server apparatus, in accordance with the remaining amount of the battery of the communication terminal apparatus, whether or not to display the image included in the acquired multimedia data on the display unit is decided, or whether or not to output the sound included in the acquired multimedia data from the conversation unit is decided, so that it is possible to stop display of the image or output of the sound in a case where the remaining amount of the battery is small, thus making it possible to achieve saving of the battery.

(9) Moreover, a communication system of the invention is a communication system in which a communication terminal apparatus performs telephone communications via a server apparatus provided on a communication network, in which the communication terminal apparatus includes a conversation unit that inputs therein a sound via a transmitter and outputs a sound from a receiver, an input unit that receives an operation of a user, a display unit that displays an image, a communication unit that establishes communications with the server apparatus on the basis of a telephone number of a calling destination, which is from the input unit, and a notification unit that, in a case where the communication unit acquires multimedia data corresponding to the telephone number of the calling destination from the server apparatus after the communications are established with the server apparatus, notifies the user of acquisition of the multimedia data, and, in a case of receiving, with a telephone number of a calling destination, a request to establish the communications from the communication terminal apparatus, the server apparatus transmits, to the communication terminal apparatus, multimedia data that is registered in advance by a user of the telephone number of the calling destination and corresponds to the telephone number of the calling destination.

As above, the communications with the server apparatus provided on the communication network is established on the basis of the telephone number of the calling destination, which is input from the input unit, and, in the case where the communication unit acquires multimedia data corresponding to the telephone number of the calling destination from the server apparatus after the communications are established with the server apparatus, the user is notified of the acquisition of the multimedia data, so that it is possible to make the user notice the acquisition of the multimedia data. Thereby, it is possible to reliably make the user listen to or view the multimedia data.

(10) Moreover, in the communication system of the invention, the server apparatus monitors communication traffic, and stops transmission of the multimedia data, in a case where the communication traffic that is being monitored exceeds a constant threshold.

As above, in the case where the communication traffic that is being monitored exceeds the constant threshold, the transmission of the multimedia data is stopped, so that it is possible to avoid an increase in the communication traffic.

### Advantageous Effects of Invention

According to the present invention, it is possible to make a user notice acquisition of multimedia data. Thereby, it is possible to make the user listen to or view the multimedia data instead of ring-back tone.

### BRIEF DESCRIPTION OF DRAWINGS

FIG. 1 is a view illustrating a schematic configuration of a communication system according to the present embodiment.

FIG. 2 is a block diagram illustrating a schematic configuration of a calling terminal as a communication terminal apparatus.

FIG. 3 is a sequence chart illustrating an operation of the communication system according to the present embodiment.

### DESCRIPTION OF EMBODIMENTS

An embodiment of the invention will be described below with reference to the drawings.

### [Configuration of Communication System]

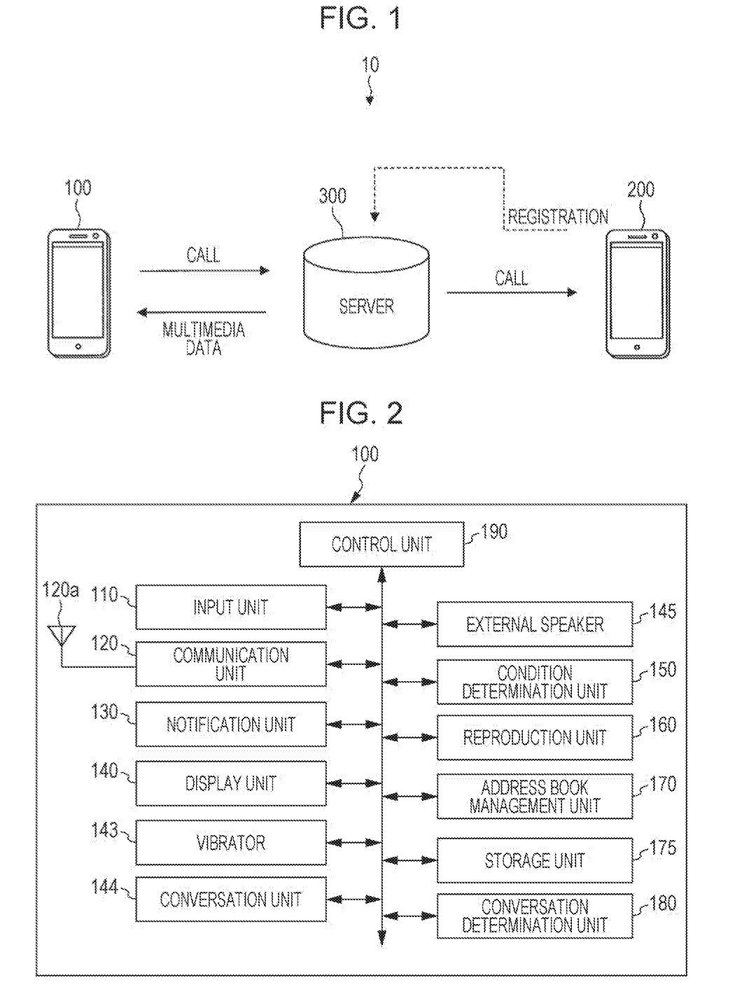

FIG. 1 is a view illustrating a schematic configuration of a communication system according to the present embodiment. A communication system 10 is constituted by a calling terminal 100 and a called terminal 200, each of which serves as a communication terminal apparatus, and a server 300. Each of the calling terminal 100 and the called terminal 200 is a communication terminal apparatus that enables telephone communications and reproduction of multimedia data via a communication network, and examples thereof include a mobile telephone, a tablet terminal, a PC with a headset, and the like. The server 300 establishes communications between the calling terminal 100 and the called terminal 200, and connects the calling terminal 100 and the called terminal 200 during a call and conversation. The communication network includes the Internet, a mobile communication network, a public switched telephone network, and a wireless LAN. In the communication system 10, multimedia data is provided to the calling terminal 100 that calls the called terminal 200 instead of ring-back tone.

The multimedia data to be provided to the calling terminal 100 is able to be selected by a user of the called terminal 200, and able to be registered in the server 300 from the called terminal 200 in association with an ID of a calling person. Examples of the ID include a telephone number of the calling terminal 100, an account of an IP telephone, an account of an SNS (social networking service), and the like. The multimedia data includes data of a video (a still image, a moving image, or a text), a sound (a piece of music, a natural sound, or a voice), and the like. Accessory information such as text information describing a content or a state of the multimedia data may accompany the multimedia data. It is possible to sort pieces of multimedia data, which is to be registered in the server 300, by calling persons, in a case where the calling persons are divided into groups, by the groups, by ages, sexes, or occupations of the calling persons, or, furthermore, by time zones of calling. Note that, the registration of the multimedia data is possible as long as communications are allowed, and is therefore able to be performed not only from a mobile telephone but also from a PC that does not have a conversation function or the like.

As illustrated in FIG. 1, when the calling terminal 100 calls the called terminal 200, a call is made to the called terminal 200 via the server 300. Meanwhile, the multimedia data is transmitted to the calling terminal 100, and the multimedia data is reproduced in the calling terminal 100. In the present embodiment, in a case where the multimedia data is reproduced in the calling terminal 100, notification is performed in various methods in order to make a user recognize the reproduction of the multimedia data. Note that, after a predetermined period set by a calling person has elapsed, the calling terminal 100 is also able to transmit a signal that instructs deletion of registered information of the multimedia data to the server 300. The signal may be a signal of any layer of an OSI reference model (any signal of layers 1 to 7 of the OSI reference model).

### [Configuration of Communication Terminal Apparatus]

FIG. 2 is a block diagram illustrating a schematic configuration of the calling terminal 100 as a communication terminal apparatus. An input unit 110 has a function of receiving an input operation of a user and is constituted by, for example, a touch panel, a key board, or the like. A communication unit 120 transmits or receives a wireless signal via an antenna 120a. Moreover, the communication unit 120 establishes communications with the server 300 provided on the communication network on the basis of a telephone number of a calling destination, which is input from the input unit 110.

In a case where the communication unit 120 acquires multimedia data corresponding to the telephone number of the calling destination from the server 300 after the communications are established with the server 300, a notification unit 130 notifies a user of the acquisition of the multimedia data. As means by which the notification unit 130 executes the notification, for example, it is possible to cause a display unit 140 described below to reproduce a video for visual notification, to cause a vibrator 143 to vibrate for tactual notification, or to cause a sound to be output from a receiver of a conversation unit 144 or a sound to be output from an external speaker 145 for aural notification.

The display unit 140 has a function of displaying an image, and is able to be constituted by, for example, a liquid crystal display. The vibrator 143 vibrates a housing of the calling terminal 100 on the basis of an instruction from the notification unit 130. The conversation unit 144 is provided with a transmitter and the receiver, and has a function of converting a sound of the user into an electric signal and outputting the resultant and a function of converting a received electric signal into a sound and outputting the resultant. The external speaker 145 outputs a sound. The external speaker 145 is able to output a louder sound than the receiver, and able to make the user recognize the sound even from a place apart from an ear of the user.

On the basis of a predetermined condition, a condition determination unit 150 determinates whether or not multimedia data is to be reproduced. For example, in a case where a user sets a condition for refusing to look at an advertisement in advance, whether or not multimedia data acquired from the server 300 includes an advertisement is determined, and in a case where, as a result of the determination, the multimedia data includes an advertisement, the condition determination unit 150 is able to perform control so as to prohibit reproduction. Moreover, configuration in which so-called “rating” is set and, in a case where multimedia data includes a harmful image or the like, the condition determination unit 150 excludes the multimedia data may be provided. A reproduction unit 160 reproduces multimedia data acquired by the communication unit 120. In addition, the reproduction unit 160 reproduces or stops the multimedia data in accordance with a determination result by a conversation determination unit 180 described below.

A control unit 190 monitors a remaining amount of a battery (not illustrated) of the calling terminal 100, and controls operations of the conversation unit 144 and the display unit 140 and controls the other constituents. In a case where the communication unit 120 acquires multimedia data from the server 300, the control unit 190 decides whether or not to display an image included in the acquired multimedia data on the display unit 140 in accordance with the remaining amount of the battery of the calling terminal 100. Moreover, the control unit 190 decides whether or not to output a sound included in the acquired multimedia data from the conversation unit 144 or the external speaker 145.

An address book management unit 170 has a function of storing a name, a telephone number, a mail address and the like of a communication partner and displaying the stored information on the display unit 140 in a sorted manner. Moreover, in a case where multimedia data has already been registered in association with the telephone number of the calling destination, the address book management unit 170 may automatically replace the multimedia data with multimedia data which is newly received. Thereby, for example, multimedia data registered in an address book is able to be updated and to be used as the latest address book. Note that, not only multimedia data but also, by using accessory information thereof, a specific list may be updated. A storage unit 175 is able to store an operating system, various applications, and the like and store multimedia data acquired from the server 300. In a case where the communication unit 120 acquires multimedia data, the conversation determination unit 180 determines whether or not a proximity sensor (not illustrated) of the calling terminal 100 is reacting. Note that, characteristic functions of the invention have been described in accordance with each constituent for convenience of description, but the invention is not thereby limited to hardware. It is possible to realize the invention not only by hardware but also by software or a combination thereof.

### [Operation of Communication System]

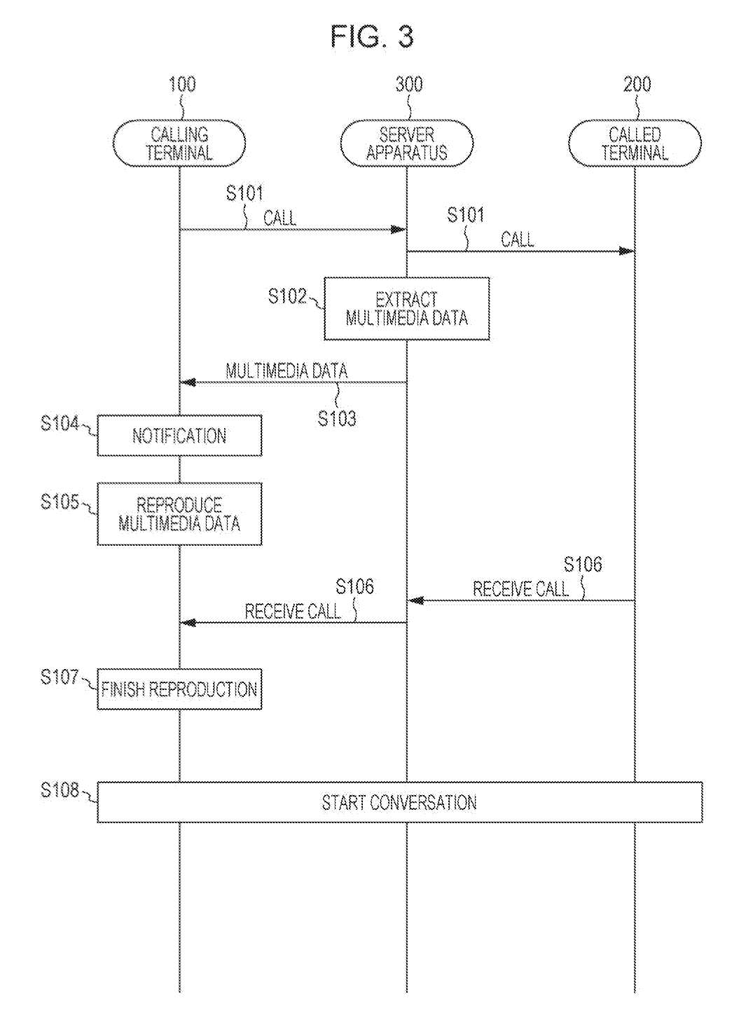

Next, description will be given for an operation of the communication system according to the present embodiment, which is configured as above. FIG. 3 is a sequence chart illustrating the operation of the communication system according to the present embodiment. As a premise of the operation, the called terminal 200 registers multimedia data substituted for ring-back tone in the server 300 with respect to a calling terminal which calls the called terminal 200. Next, when the calling terminal 100 makes a call to the called terminal 200 (step S101), the server 300 recognizes the call and extracts multimedia data to be substituted for ring-back tone (step S102). Then, the server 300 transmits the extracted multimedia data to the calling terminal 100 (step S103).

When the calling terminal 100 acquires the multimedia data from the server 300, the calling terminal 100 makes notification for causing a user to recognize the acquisition of the multimedia data (step S104). Specifically, the notification is made by any or all of generation of vibrations by the vibrator 143, output of a sound, which indicates that the multimedia data is acquired, from the receiver of the conversation unit 144, display of an image, which indicates that the multimedia data is acquired, on the display unit 140, and output of a sound, which indicates that the multimedia data is acquired, from the external speaker 145.

Next, the multimedia data is reproduced (step S105). It is also possible to determine here whether or not the proximity sensor of the calling terminal 100 is reacting, and to reproduce or stop the multimedia data in accordance with a determination result. That is, in a case where the proximity sensor is reacting, the multimedia data is reproduced to thereby make the user to listen to the sound, and, on the other hand, in a case where the proximity sensor is not reacting, the multimedia data is stopped to thereby avoid reproduction of the sound which is not to be listened to by the user. Moreover, in the case where the proximity sensor is not reacting, it is possible to make the user view a video by reproducing the multimedia data, and, on the other hand, in the case where the proximity sensor is reacting, by stopping the multimedia data, it is possible to avoid reproduction of the video which is not to be viewed by the user. Furthermore, in a case where the remaining amount of the battery of the calling terminal 100 is small, control may be performed so as not to display an image included in the acquired multimedia data or control may be performed so as not to output a sound included in the acquired multimedia data.

Then, when the called terminal 200 responds to the call as reception of the call (step S106), the reproduction of the multimedia data is stopped (step S107) and conversation is started (step S108).

As described above, according to the present embodiment, it is possible to make a user notice acquisition of multimedia data. Thereby, it is possible to make the user listen to or view the multimedia data instead of ring-back tone.

### REFERENCE SIGNS LIST

10 communication system
100 calling terminal (communication terminal apparatus)
110 input unit
120 communication unit
120a antenna
130 notification unit
140 display unit
143 vibrator
144 conversation unit
145 external speaker
150 condition determination unit
160 reproduction unit
170 address book management unit
175 storage unit
180 conversation determination unit
190 control unit
200 called terminal (communication terminal apparatus)
300 server (server apparatus)

1. A communication terminal apparatus that performs telephone communications via a communication network, comprising;
a conversation unit that inputs therein a sound via a transmitter and outputs a sound from a receiver,
an input unit that receives an operation of a user,
a display unit that displays an image;
a communication unit that establishes communications with a server apparatus, which is provided on the communication network, on a basis of a telephone number of a calling destination, which is input from the input unit; and
a notification unit that, in a case where the communication unit acquires multimedia data corresponding to the telephone number of the calling destination from the server apparatus after the communications are established with the server apparatus, notifies the user of acquisition of the multimedia data.

2. The communication terminal apparatus according to claim 1, further comprising
a vibrator that vibrates a housing of the communication terminal apparatus, wherein
the notification unit causes the vibrator to function, in a case where the communication unit acquires multimedia data.

3. The communication terminal apparatus according to claim 1, wherein,
in the case where the communication unit acquires multimedia data, the notification unit outputs, from the receiver, a sound which indicates that the multimedia data is acquired.

4. The communication terminal apparatus according to claim 1, wherein,
in the case where the communication unit acquires multimedia data, the notification unit displays, on the display unit, an image which indicates that the multimedia data is acquired.

5. The communication terminal apparatus according to claim 1, further comprising
an external speaker that outputs a sound, wherein,
in the case where the communication unit acquires multimedia data, the notification unit outputs, from the external speaker, a sound which indicates that the multimedia data is acquired.

6. The communication terminal apparatus according to claim 1, further comprising:
a conversation determination unit that, in the case where the communication unit acquires multimedia data, determines whether or not a proximity sensor of the communication terminal apparatus is reacting; and
a reproduction unit that reproduces or stops the multimedia data in accordance with a result of the determination.

7. The communication terminal apparatus according to claim 1, wherein,
in a case where the communication unit acquires multimedia data from the server apparatus, the display unit displays an image included in the acquired multimedia data, or the conversation unit outputs a sound included in the acquired multimedia data from the receiver.

8. The communication terminal apparatus according to claim 7, further comprising
a control unit that monitors a remaining amount of a battery of the communication terminal apparatus and controls operations of the conversation unit and the display unit, wherein,
in the case where the communication unit acquires multimedia data from the server apparatus, in accordance with the remaining amount of the battery of the communication terminal apparatus, the control unit decides whether or not to display the image included in the acquired multimedia data, or decides whether or not to output the sound included in the acquired multimedia data.

9. A communication system in which a communication terminal apparatus performs telephone communications via a server apparatus provided on a communication network, wherein
the communication terminal apparatus includes
a conversation unit that inputs therein a sound via a transmitter and outputs a sound from a receiver,
an input unit that receives an operation of a user,
a display unit that displays an image,
a communication unit that establishes communications with the server apparatus on a basis of a telephone number of a calling destination, which is from the input unit, and
a notification unit that, in a case where the communication unit acquires multimedia data corresponding to the telephone number of the calling destination from the server apparatus after the communications are established with the server apparatus, notifies the user of acquisition of the multimedia data, and,
in a case of receiving, with a telephone number of a calling destination, a request to establish the communications from the communication terminal apparatus, the server apparatus transmits, to the communication terminal apparatus, multimedia data that is registered in advance by a user of the telephone number of the calling destination and corresponds to the telephone number of the calling destination.

10. The communication system according to claim 7, wherein
the server apparatus monitors communication traffic, and stops transmission of the multimedia data, in a case where the communication traffic that is being monitored exceeds a constant threshold.
